(19) United States
(12) Patent Application Publication
(10) Pub. No.: US 2022/0111358 A1
(43) Pub. Date: Apr. 14, 2022

(54) SINGLE ATOM CATALYST HAVING A TWO DIMENSIONAL SUPPORT MATERIAL

(71) Applicant: KING ABDULLAH UNIVERSITY OF SCIENCE AND TECHNOLOGY, Thuwal (SA)

(72) Inventors: Jr-Hau HE, Thuwal (SA); Vinoth RAMALINGAM, Thuwal (SA); Purushothaman VARADHAN, Thuwal (SA); Hui-Chun FU, Thuwal (SA)

(21) Appl. No.: 17/423,491

(22) PCT Filed: Feb. 18, 2020
(86) PCT No.: PCT/IB2020/051345

§ 371 Date: Jul. 16, 2021

Related U.S. Application Data
(60) Provisional application No. 62/807,474, filed on Feb. 19, 2019.

(51) Int. Cl. B01J 23/46; C25B 1/04; C25B 11/067; C25B 11/081; B01J 27/22; C25B 11/049; B01J 35/00

(52) U.S. Cl. CPC B01J 23/462; C25B 1/04; C25B 11/067; B01J 35/004; B01J 27/22; C25B 11/049; C25B 11/081

(57) ABSTRACT

A method for forming a single atom catalyst on a two-dimensional support material involves providing the two-dimensional support material. The two-dimensional support material is combined with at least two heteroatoms and a metal to form a solution. Liquid is removed from the solution to form a material that includes the two-dimensional support material, the at least two heteroatoms, and the metal. The material including the two-dimensional support material, the at least two heteroatoms, and the metal is heated to form the single atom catalyst that includes single atoms of the metal. The at least two heteroatoms bind the single atoms of the metal to, and stabilize the single atoms of the metal on, the two-dimensional support material.

### CROSS-REFERENCE TO RELATED APPLICATIONS

This application claims priority to U.S. Provisional Patent Application No. 62/807,474, filed on Feb. 19, 2019, entitled “MXENE-SINGLE ATOM CATALYST FOR ELECTROCHEMICAL AND PHOTOELECTROCHEMICAL HYDROGEN PRODUCTION,” the disclosure of which is incorporated herein by reference in its entirety.

### BACKGROUND

### Technical Field

Embodiments of the disclosed subject matter generally relate to single atom catalysts having a single atom metal bound to, and stabilized by, two heteroatoms on a two-dimensional support material.

### Discussion of the Background

Catalysts, including electrocatalysts, are used in a variety of different applications, including in water-splitting applications, as well as in supercapacitors, batteries, etc. Device efficiency is important in all of these applications, and thus is a significant consideration when designing catalysts for these applications.

Another design consideration for catalysts is the type of metal used in the catalyst. Typically, the best performing metals for catalysts are also the most expensive metals, such as platinum. To address this issue, research has been conducted into using single atom metal in the catalyst because doing so provides a larger exposed surface area of the metal for the catalytic reaction, and thus significantly less of the metal is required to achieve the same performance as using bulk metal.

Reference Document [1] discloses using single platinum atoms on MXene for hydrogen evolution reaction (HER) as part of a water splitting process. Specifically, quaternary transition metal carbides (MAX) phase Mo₂TiAlC₂ was etched to remove the aluminum layers and form Mo₂TiC₂Tₓ MXene nanosheets. The etching process produced Mo vacancies on the surface of the MXene nanosheets. Platinum from a counter electrode was then trapped by the Mo vacancy sites to produce a Mo₂TiC₂Tₓ-Pt_{SA} catalyst. Reference Document [1] concludes that this technique results in the single platinum atoms being perfectly anchored to the sites of the Mo vacancies. Although the technique disclosed in Reference Document [1] produced a better performing catalyst than prior techniques, it requires the use of expensive platinum because Reference Document [1] states that this is the most efficient catalyst for hydrogen evolution reaction. Further, the system produced in Reference Document [1] involves three different metals, such as Mo, Ti, and Pt. Although the additional metal atoms improve performance, the increased number of different metals also highly limits the commercialization of the device due to the complex production techniques required.

Thus, there is a need for catalysts and methods for producing catalysts that are more efficient than conventional catalysts without requiring expensive metals and that minimizes the different types of metals employed for the catalyst.

### SUMMARY

According to an embodiment, there is method for forming a single atom catalyst on a two-dimensional support material. The two-dimensional support material is provided and is combined with at least two heteroatoms and a metal to form a solution. Liquid is removed from the solution to form a material that includes the two-dimensional support material, the at least two heteroatoms, and the metal. The material including the two-dimensional support material, the at least two heteroatoms, and the metal is heated to form the single atom catalyst comprising single atoms of the metal. The at least two heteroatoms bind the single atoms of the metal to, and stabilize the single atoms of the metal on, the two-dimensional support material.

According to another embodiment, there is a single atom catalyst, which includes a two-dimensional support material, at least one single atom metal, and first and second heteroatoms binding the at least one single atom metal to, and stabilizing the at least one single atom metal on, the two-dimensional support material.

According to a further embodiment, there is a water splitting device, which includes a metal anode and a semiconductor photocathode. The semiconductor photocathode is spaced apart from the metal anode and has a first side facing the metal anode. The first side of the photocathode includes a single atom catalyst, which includes a two-dimensional support material, at least one single atom metal, and first and second heteroatoms binding the at least one single atom metal to, and stabilizes the at least one single atom metal on, the two-dimensional support material.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a flow diagram of a method for forming a single atom catalyst according to embodiments;

FIG. 2 is an atomic model of a single atom catalyst having a two-dimensional support material according to embodiments;

FIG. 3 is a schematic diagram of a water-splitting device with a single atom catalyst according to embodiments;

FIGS. 4A and 4B are schematic diagrams of a method for forming a single atom catalyst according to embodiments;

FIG. 5 is a high-angle annular dark-field scanning transmission electron microscopy (HAADF-STEM) image of a single atom catalyst according to embodiments;

FIG. 6 illustrates the HER polarization curves for a number of different materials according to embodiments;

FIG. 7 illustrates a band structure diagram of a single atom catalyst photocathode according to embodiments;

FIG. 8 illustrates current density-voltage (J-V) characteristic curves of two different catalysts integrated on a photocathode according to embodiments;

FIG. 9 is a graph illustrating photocurrent density of a number of catalysts on a photocathode according to embodiments; and

FIG. 10 is a graph illustrating onset potential of a number of catalysts on a photocathode according to embodiments.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of single atom catalysts.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

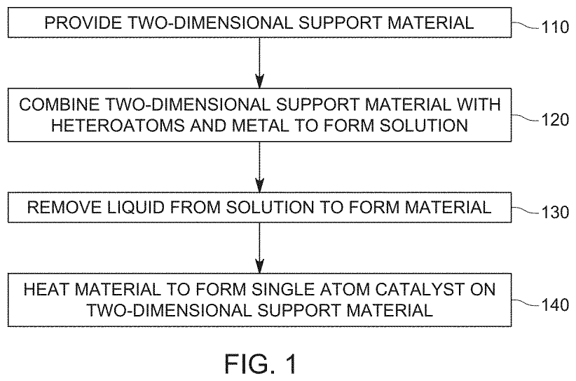

FIG. 1 is a flow diagram of a method for producing a single atom catalyst on a two-dimensional support material according to embodiments. The two-dimensional support material is provided (step 110) and combined with at least two heteroatoms and a metal to form a solution (step 120). Liquid is removed from the solution to form a material comprising the two-dimensional support material, the at least two heteroatoms, and the metal (step 130). The material comprising the two-dimensional support material, the at least two heteroatoms, and the metal is heated to form the single atom catalyst comprising single atoms of the metal (step 140). The at least two heteroatoms bind the single atoms of the metal to, and stabilize the single atom metal on, the support material.

Those skilled in the art will recognize that the term “two-dimensional support material” refers to two-dimensional materials that are sometimes referred to as single-layer materials, which are crystalline materials consisting of a single layer, or a few layers, of atoms.

The method described above can employ any type of two-dimensional support material, including graphene, MXenes, etc. In one embodiment, the two-dimensional support material is a titanium carbide Tₓ (Ti₃C₂Tₓ) MXene. The heteroatoms can be any type of heteroatoms, which in one embodiment includes sulfur and nitrogen. The liquid, which can be any type of liquid, such as water, can be removed from the solution using, for example, freeze-drying. The single atom of metal can be any type of single metal, preferably a single metal having properties that are beneficial for catalytic reaction. The single atom metal can be, for example, single atom platinum, single atom, ruthenium, etc. The heating can involve, for example, annealing.

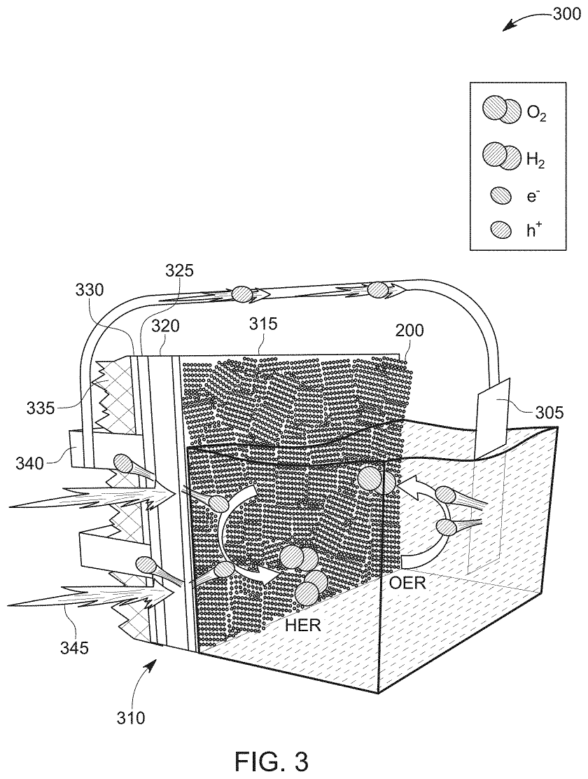

It should be recognized that although the method described above is in connection with the formation of a single atom catalyst on a two-dimensional support material, the method can be used to generate a number of single atom catalysts on a number of two-dimensional support material. As will be described in more detail below in connection with the semiconductor photocathode of FIG. 3, a number of single atom catalysts on a number of two-dimensional support material are employed to provide the catalytic activity necessary for the water splitting application. Similarly, other applications can involve a number of single atom catalysts on a number of two-dimensional support material. Moreover, it should be recognized that a two-dimensional support material may include a number of single atom metals (typically the same type of metal), each of which is bound to, and stabilized by, the first and second heteroatoms.

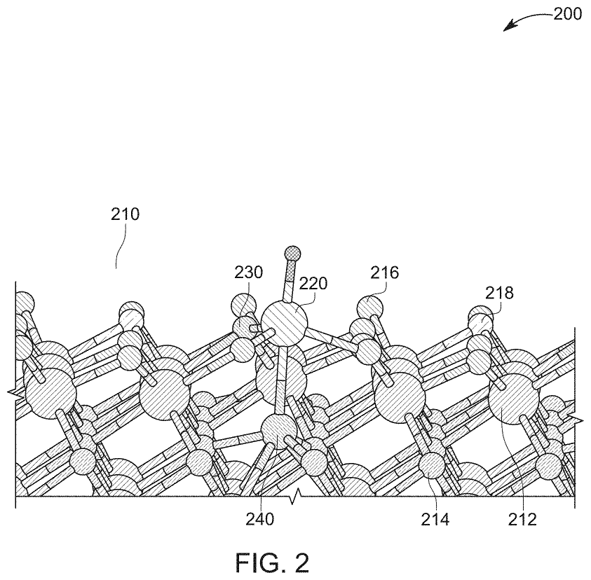

An atomic model of a single atom catalyst having a two-dimensional support material according to embodiments is illustrated in FIG. 2. The single atom catalyst 200 includes a two-dimensional support material 210, at least one single atom metal 220, and a first 230 and second 240 heteroatoms binding the at least one single atom metal 220 to the two-dimensional support material 210. As will be appreciated from FIG. 2, the first 230 and second 240 heteroatoms are not the sole source of binding of the single atom metal 220. However, as detailed below, the binding of the single atom metal 220 to, and stabilizes the single atom metal 220 on, the two-dimensional support material 210 by the first 230 and second 240 heteroatoms stabilizes the single atom metal 220, and contributes to the overall improvement in the performance of the catalyst.

Assuming, for example, that the two-dimensional support material 210 is a titanium carbide Tₓ (Ti₃C₂Tₓ) MXene, the two-dimensional support material includes titanium atoms 212 (only one of which is labeled), carbon atoms 214 (only one of which is labeled), and oxygen atoms 216 (only one of which is labeled). In the illustrated embodiment, the two-dimensional support material 210 also includes fluorene atoms 218, which become deposited on the MXene during the process of forming the MXene from the MAX phase, as will be detailed below. It should be recognized that if the MXene is formed from the MAX phase in a different manner, the MXene may include a different atom in place of the fluorene atoms 218.

The disclosed single atom catalyst can be employed in a variety of different applications. One such application is for water-splitting, an example of a water-splitting device using the disclosed single atom catalyst is illustrated in FIG. 3. The water splitting device 300 comprises a metal anode 305 and a semiconductor photocathode 310, spaced apart from the metal anode 305 and having a first side facing the metal anode 305. The first side of the photocathode comprises the disclosed single atom catalyst 200. Consistent with the discussion above and below, the single atom catalyst 200 comprises a two-dimensional support material 210, at least one single atom metal 220, and first 230 and second 240 heteroatoms binding the at least one single atom metal 220 to, and stabilizing the at least one single atom metal 220 on, the two-dimensional support material 210. In the illustrated embodiment, the semiconductor photocathode 310 is a n+np+-Si photocathode and the first side of the semiconductor photocathode comprises an n+ layer on which the single atom catalyst 200 is arranged. Beneath the n+ layer 315 is an n-Si layer 320, a silicon p+ layer 325, a passivation layer 330, and a passivation and anti-reflective layer 335. As also illustrated, the water splitting device 300 includes at least one metallic contact 340 that is electrically connected to the metal anode in a known manner (not illustrated). In an embodiment, the passivation layer 330 is a 7 nm thick Al₂O₃ layer, the passivation and anti-reflective layer 335 is a 70 nm thick SiNₓ layer, and the at least one metallic contact 340 comprises gold metal grids. In one embodiment, the two-dimensional support material 210 is a titanium carbide Tₓ, Ti₃C₂Tₓ MXene, the at least one single atom metal 220 is ruthenium, the first heteroatom 230 is sulfur, and the second heteroatom 240 is nitrogen. In other embodiments, the two-dimensional support material 210, the single atom metal 220, and the first 230 and second 240 heteroatoms are any of the elements and materials discussed above or below.

As illustrated in FIG. 3, light 345 impinging upon the second side of the semiconductor photocathode 310 causes electrons e⁻ to move through the semiconductor photocathode 310 towards the single atom catalyst 200 and holes h⁺ to move from the first side of semiconductor photocathode 310 towards the second side of the semiconductor photocathode 310. This results in the single atom catalyst 200 causing a hydrogen evolution reaction (HER) in the water to generate hydrogen atoms from the water and holes h⁺ from the metal anode 305 to cause an oxygen evolution reaction (OER) to generate oxygen (O₂) atoms from the water.

Although the specific implementation example of the disclosed single atom catalyst involved a water splitting device, the disclosed single atom catalyst can be employed in a number of different applications, including in supercapacitors, batteries, etc.

Now that an overview has been provided, a specific example will be presented in which the two-dimensional support material is an MXene (i.e., Ti₃C₂Tₓ in this specific example), the single metal atom is ruthenium, and the heteroatoms are nitrogen and sulfur. It should be recognized, however, that the findings in connection with this specific example apply to other two-dimensional support materials, other single metal atoms, and other heteroatoms. Specifically, as detailed below, the use of the heteroatoms to bind and stabilize the single atom metal significantly contributes to the improved performance. The types of two-dimensional support materials can include, but are not limited to, all MXenes, graphene, g-C₃N₄, and transition metal chalcogenides (TMDCs), such as, MoS₂, WS₂, MoSe₂, WSe₂. The types of heteroatoms can include, but are not limited to, nitrogen, sulfur, boron, and phosphorous. The types of single metal atoms include, but are not limited to, Pt, Ru, Pd, Ni, Cu, Ir, Fe, Co, Mo, Ag, and Au.

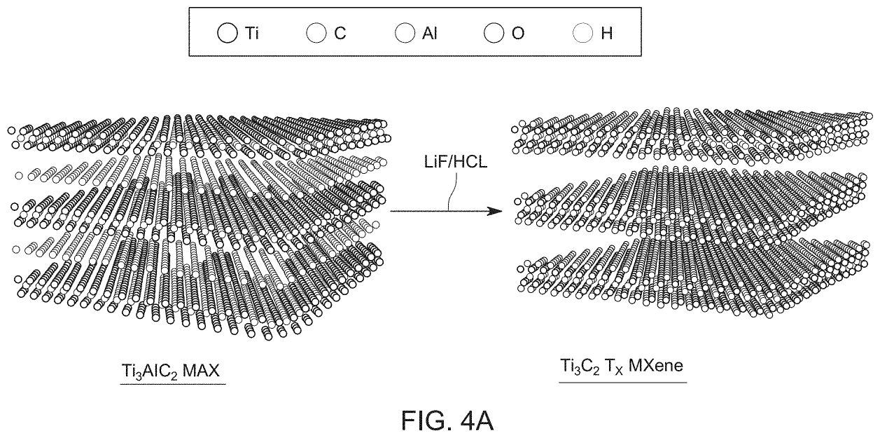

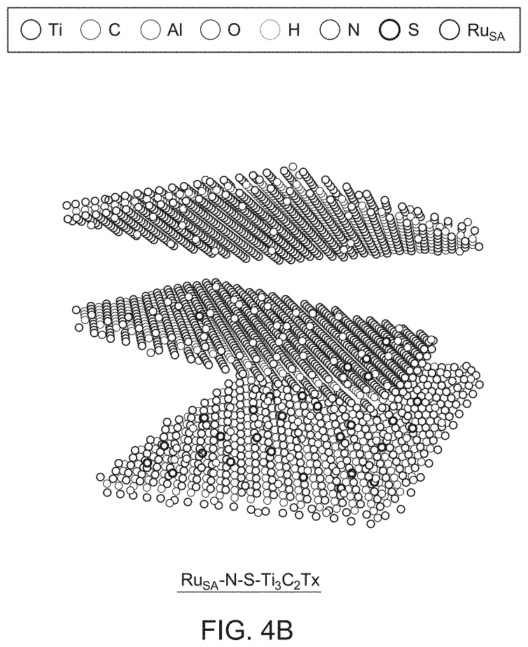

The following example involves a single atom catalyst having a Ti₃C₂Tₓ MXene support material and single atom ruthenium bound to, and stabilized by, the support material by a nitrogen and a sulfur atom, i.e., the single atom catalyst is a Ru_{SA}—N—S—Ti₃C₂Tₓ catalyst. A method for synthesizing this single atom catalyst is schematically illustrated in FIGS. 4A and 4B. The Ti₃C₂T ₓ MXene support material was prepared from MAX phase (M: transition metal, A: main group element, X: C and/or N) Ti₃AlC₂ using a lithium fluoride (LiF)/hydrochloric (HCl) acid mixture to selectively remove the Al layers from the MAX phase and thereby produce few-layered Ti₃C₂Tₓ MXene support material, as illustrated in FIG. 4a.

To prepare the Ru_{SA}—N—S—Ti₃C₂Tₓ electrocatalyst, Ti₃C₂Tₓ, RuCl₃.xH₂O, and thiourea (i.e., CH₄N₂S) were mixed together to form a solution and then the solution was freeze-dried to produce a foam material comprising the Ti₃C₂Tₓ MXene support material, the single atom ruthenium, and the sulfur and nitrogen heteroatoms. It was expected that the oxygen-rich surface functional groups (O and OH groups) on the Ti₃C₂Tₓ MXene material sheets would interact with or adsorb the Ru cations, to promote the incorporation of the single atom ruthenium (Ru_{SA}) onto the Ti₃C₂Tₓ MXene support material. Moreover, the freeze-drying process not only prevented the restacking of the Ti₃C₂Tₓ MXene support material sheets but also helped achieve the homogeneous distribution of the single atom ruthenium ions on the Ti₃C₂Tₓ MXene support material sheets. The foam was then annealed at 500° C. under inert atmosphere, which led to the simultaneous doping of nitrogen, sulfur, and single atom ruthenium onto the Ti₃C₂T, MXene material sheets, as illustrated in FIG. 4B.

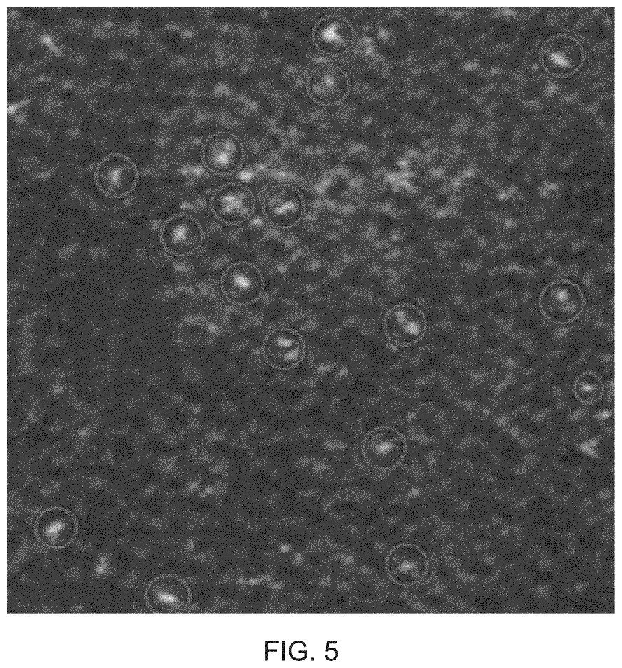

Transmission electron microscopy (TEM) images of the bare Ti₃C₂Tₓ MXene material sheet indicated the successful removal of the aluminum layer from the Ti₃AlC₂ MAX starting material. Field emission-scanning electron microscopy (FESEM) of the final Ru_{SA}—N—S—Ti₃C₂Tₓ single atom catalyst revealed the formation of a well-defined two-dimensional nanosheet structure. Likewise, the TEM images further confirmed the layered structure of the Ru_{SA}—N—S—Ti₃C₂Tₓ single atom catalyst, which featured smooth surfaces and edges. No obvious Ru nanoparticle formation was observed in the Ru_{SA}—N—S—Ti₃C₂Tₓ single atom catalyst. FIG. 5 illustrates a high-angle annular dark-field scanning transmission electron microscopy (HAADF-STEM) image of the Ru_{SA}—N—S—Ti₃C₂Tₓ catalyst, in which the small, homogeneously distributed bright dots of <1 nm in size (i.e., the circled dots) confirmed the presence of atomically dispersed single atom ruthenium (Ru_{SA}) isolated on the Ti₃C₂Tₓ support material. The single atom ruthenium loading was estimated to be 1.2 wt % based on inductively coupled plasma-optical emission spectroscopy (ICP-OES) analysis. Furthermore, scanning transmission electron microscopy-energy dispersive X-ray (STEM-EDX) mapping revealed the existence and uniform distribution of Ti, C, O, N, S, and Ru elements in the Ru_{SA}—N—S—Ti₃C₂Tₓ single atom catalyst. These results strongly indicated that the isolated single atom ruthenium (Ru_{SA}) was homogenously distributed in the Ru_{SA}—N—S—Ti₃C₂Tₓ single atom catalyst.

The X-ray diffraction (XRD) patterns of the Ti₃C₂Tₓ MXene support material showed that a strong (002) peak is shifted to a lower angle (2θ=9°) compared to that of the Ti₃AlC₂ MAX starting material, which suggested the successful etching of aluminum layers from the MAX phase and the formation of the MXene support material.

X-ray photoelectron spectroscopy (XPS) and X-ray absorption fine structure spectroscopy (XAFS) were performed to investigate the existence and electronic states of single ruthenium atoms in the Ru_{SA}—N—S—Ti₃C₂Tₓ single atom catalyst. The existence of Ti, C, O, and F elements in the survey scan indicated the successful preparation of the Ti₃C₂Tₓ MXene support material, which was further supported by the Ti—C bond observed in the high-resolution C1s spectrum and the intense Ti³₊ peak identified in the high-resolution Ti2p spectrum. The survey scan spectra of the Ru_{SA}—N—S—Ti₃C₂Tₓ catalyst showed the presence of Ti, C, O, N, S, and Ru elements, indicating the doping of Ru, N, and S on the Ti₃C₂Tₓ MXene.

High-resolution C1s and Ru₃d XPS spectra of the Ru_{SA}—N—S—Ti₃C₂Tₓ single atom catalyst and a control made without ruthenium (i.e., the control was N—S—Ti₃C₂Tₓ) were obtained. The binding energy peaks identified for the Ru_{SA}—N—S—Ti₃C₂Tₓ single atom catalyst at 281.8, 282.2, 285.0, 285.7, 286.6, and 288.4 eV correspond to C—Ti—N, C—Ti, graphitic C—C, C—N, C—O, and C—O, respectively. Compared with the N—S—Ti₃C₂Tₓ, an additional small peak observed for the Ru_{SA}—N—S—Ti₃C₂Tₓ single atom catalyst at 280.6 eV located between the oxidation state of Ru(0) and Re indicated the different oxidation states of ruthenium in the Ru_{SA}—N—S—Ti₃C₂Tₓ single atom catalyst. Moreover, it was difficult to distinguish the Ru₃d_{3/2} peak from the graphitic C—C signals because of spectral overlap in the energy range around 285.0 eV. The high-resolution N1s XPS spectrum of N—S—Ti₃C₂Tₓ exhibited peaks at 396.3, 397.5, 398.8, and 399.4 eV, which are assigned to Ti—N, pyridinic-N, N—Ti—O, and pyrollic-N bonds, respectively. However, the pyrollic-N component of the Ru_{SA}—N—S—Ti₃C₂Tₓ single atom catalyst was observed at 400.2 eV, which is ≈0.8 eV higher than the pyrollic-N of N—S—Ti₃C₂Tₓ. It was believed that this was possibly due to the chemical interaction between the single atom ruthenium (Ru_{SA}) and the surrounding nitrogen (N) atoms on the single atom catalyst MXene support material.

The high-resolution S2p spectrum of Ru_{SA}—N—S—Ti₃C₂Tₓ was deconvoluted into six different components, including S—Ti (160.6 eV), chemisorbed S (161.8 eV), S—Ru (162.5 eV), S—C (163.8 and 165.0 eV), and sulfate species (168.0 eV). The Ru—N bond and S—Ru bond identified in the high-resolution N1s and high-resolution S2p XPS results clearly confirmed that the single atom ruthenium (Ru_{SA}) were coordinated with both nitrogen (N) and sulfur (S) in the Ru_{SA}—N—S—Ti₃C₂Tₓ single atom catalyst.

The Ti2p and Ru3p XPS spectra of the Ru_{SA}—N—S—Ti₃C₂Tₓ single atom catalyst showed a binding energy peak at 455.1 eV, which is assigned to Ti—C bonds in Ti₃C₂T, MXene support material. Two peaks located at 456.6 and 462.5 eV were related to the Ti³⁺ signal of the Ti₃C₂Tₓ support material. In addition, the peaks at 455.7, 458.8, and 464.3 eV corresponded to Ti—N, Ti—OH, and Ti—O bonds, respectively. A peak at 461.4 eV is attributed to Ru(0) or Ti²⁺.

To gain insight into the dispersion of ruthenium (Ru) species on the Ru_{SA}—N—S—Ti₃C₂Tₓ single atom catalyst, the chemical state and coordination environment of the single atom ruthenium (Ru_{SA}) was investigated using X-ray absorption fine structure spectroscopy (XAFS). The Fourier transform-X-ray absorption fine structure (FT-EXAFS) spectrum of the Ru_{SA}—N—S—Ti₃C₂Tₓ single atom catalyst exhibited a superimposed peak at 1.67 Å, which was attributed to both Ru—N(O) and Ru—S scattering pairs. Compared to ruthenium foil and RuO₂, the absence of Ru—Ru and Ru—O scattering pairs in the Ru_{SA}—N—S—Ti₃C₂Tₓ single atom catalyst indicated the existence of atomically dispersed single atom ruthenium (Ru_{SA}) isolated on the MXene support material. Furthermore, quantitative EXAFS curve fitting analysis was performed to study the bonding environment of the single atom ruthenium (Ru_{SA}). The coordination number of Ru—N(O) bonding in the first coordination bonding sphere was estimated to be 3.6 at a distance of 2.09 Å. Moreover, an additional coordination sphere with a coordination number of 1.1 at a distance of 2.37 Å corresponded to the Ru—S bonding configuration. These results confirmed the successful coordination of single atom ruthenium (Ru_{SA}) with both nitrogen (N) and sulfur (S) in the Ru_{SA}—N—S—Ti₃C₂Tₓ single atom catalyst, which was consistent with the XPS results.

Normalized ruthenium k-edge X-ray absorption near edge structure (XANES) spectra were obtained for ruthenium foil, RuO₂, and the Ru_{SA}—N—S—Ti₃C₂Tₓ single atom catalyst. The ruthenium k-edge XANES profile of the Ru_{SA}—N—STi₃C₂Tₓ single atom catalyst was entirely different from those of the ruthenium foil and RuO₂ XANES profiles, which indicated the different oxidation state of the single atom ruthenium (Ru_{SA}) and further confirming the chemical coordination of the single atom ruthenium (Ru_{SA}) with the nitrogen (N) and sulfur (S) species. Therefore, the EXAFS and XANES results confirmed the strong electronic coupling between isolated single atom ruthenium (Ru_{SA}) and the Ti₃C₂Tₓ MXene support material via the nitrogen (N) and sulfur (S) atoms.

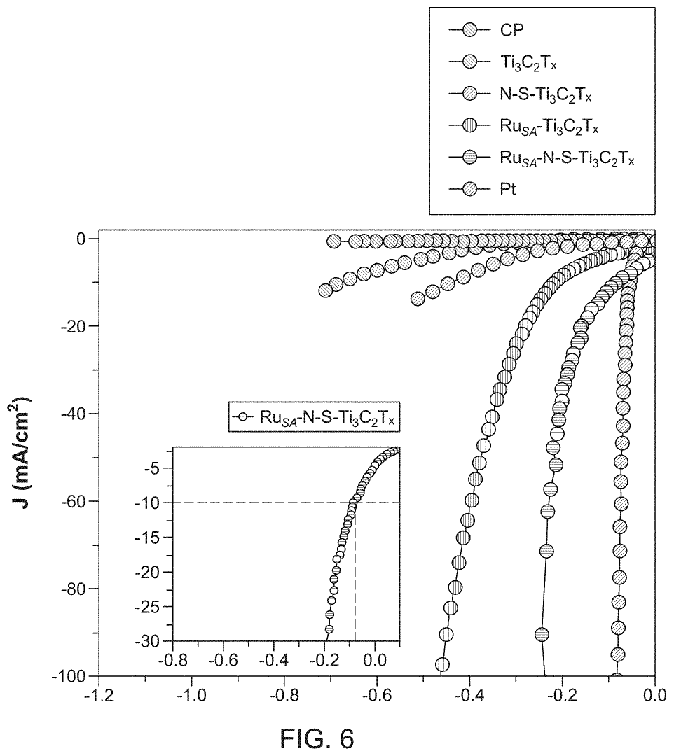

HER polarization curves were obtained for bare carbon paper (CP), Ti₃C₂Tₓ, N—S≤Ti₃C₂Tₓ, Ru_{SA}—Ti₃C₂Tₓ, and Ru_{SA}—N—S—Ti₃C₂Tₓ catalysts in 0.5 m H₂SO₄ electrolyte, which are illustrated in FIG. 6. As illustrated, the current densities of Ru_{SA}—Ti₃C₂Tₓ and Ru_{SA}—N—STi₃C₂Tₓ catalysts were not in the baseline at zero overpotential, which might have been due to the underpotential hydrogen adsorption effect of precious ruthenium metal and the capacitance effect of nanocarbons from the Ti₃C₂Tₓ MXene support material that influenced the current starting points not at zero. The Ti₃C₂Tₓ, N—S—Ti₃C₂Tₓ, and Ru_{SA}—Ti₃C₂Tₓ catalysts featured large overpotential values of 673, 453, and 215 mV, respectively, to reach a current density of 10 mA cm⁻². Remarkably, the Ru_{SA}—N—S—Ti₃C₂Tₓ single atom catalyst exhibited nearly zero onset potential (onset) and the smallest overpotentials of 76 and 237 mV to attain 10 and 100 mA cm^{—2}, respectively. This demonstrated the exceptional electrocatalytic HER performance of the Ru_{SA}—N—STi₃C₂Tₓ single atom catalyst, which was believed to be due to the chemical interactions of the single atom ruthenium (Ru_{SA}) and the MXene support material. The platinum (Pt) control sample exhibited the overpotential of 53 and 81 mV to reach the current densities of 10 and 100 mA cm⁻², respectively.

In order to study the effect of the heteroatom dual dopants (i.e., nitrogen (N) and sulfur (S)) on the HER performance, the same catalyst was prepared but this time it was only doped with nitrogen (i.e., Ru_{SA}—N—Ti₃C₂Tₓ) under identical experimental conditions using urea as the nitrogen source for the control experiment. The Ru_{SA}—N—Ti₃C₂Tₓ single atom catalyst had an overpotential of 151 mV at 10 mA cm⁻², which was ≈75 mV higher than the Ru_{SA}—N—S—Ti₃C₂Tₓ single atom catalyst. This indicated that the catalytic performance improved when sulfur atoms were also doped into the MXene substrate material. The high electronegativity and different atomic radii of the nitrogen and sulfur atoms allowed them to act as two different binding sites for the formation of the single atom ruthenium (Ru_{SA}), which helped drive the enhanced HER catalytic activity.

The reaction kinetics of the catalysts during the HER process was also studied by extracting the slope values from the Tafel plots. The Ru_{SA}—N—S—Ti₃C₂Tₓ single atom catalyst showed a Tafel slope of 90 mV dec⁻¹, which suggested that the Ru_{SA}—N—S—Ti₃C₂Tx sing atom catalyst followed the Volmer-Heyrovsky mechanism that combines a fast initial discharge reaction step (Volmer reaction: H₃O⁺+e⁻→H_{ads}+H₂O) followed by a slow electrochemical desorption reaction step (Heyrovsky reaction: H_{ads}+H₃O⁺+e⁻→H_{ads}+H₂O).

The high Tafel value of 90 mV dec⁻¹ for the Ru_{SA}—N—S—Ti₃C₂Tₓ single atom catalyst could result from the Ti₃C₂Tₓ MXene support material. In contrast, this Tafel value is higher than the Tafel values of previously reported ruthenium-based electrocatalysts. However, the value was similar to those reported for MXene based HER catalyst [Ti₂CTₓ (88 mV dec⁻¹) and Mo₂CTₓ (82 mV dec⁻¹)], which suggested that the HER active sites not only originate from the single atom ruthenium (Ru_{SA}) but also arise from the electrochemically active Ti₃C₂Tₓ MXene support material to some extent.

The HER performance of the Ru_{SA}—N—S—Ti₃C₂Tₓ single atom catalyst was further evaluated in alkaline and neutral pH electrolytes and it was found that overpotentials of 99 and 275 mV were required to achieve a current density of 10 mA cm⁻², respectively. This indicated the outstanding HER activity of the Ru_{SA}—N—S—Ti₃C₂Tₓ single atom catalyst under various pH conditions. The electrochemical impedance spectra (EIS) of Ti₃C₂Tₓ, N—S—Ti₃C₂Tₓ, and Ru_{SA}—N—S—Ti₃C₂Tₓ was measured in 0.5 m H₂SO₄. The Ru_{SA}—N—S—Ti₃C₂Tₓ single atom catalyst had a smaller charge transfer resistance than Ti₃C₂T, and N—STi₃C₂Tₓ, which showed the HER process occurs effectively at the interface between the surface of the Ru_{SA}—N—S—Ti₃C₂Tₓ single atom catalyst and the electrolyte.

The HER performance of the Ru_{SA}—N—S—Ti₃C₂Tₓ single atom catalyst was retained up to 3000 cyclic voltammetry (CV) cycles with negligible negative shift (≈17 mV) in the overpotential, indicating the long-term stability of the Ru_{SA}—N—S—Ti₃C₂Tₓ single atom catalyst. In addition, the resultant Ru_{SA}—N—S—Ti₃C₂Tₓ single atom catalyst provided excellent long-term stability in acidic electrolyte with negligible degradation in HER performance after 16 hours of reaction time, which further revealed that the single atom ruthenium (Ru_{SA}) were well preserved on the MXene support material. Moreover, the Ru_{SA}—N—S—Ti₃C₂Tₓ single atom catalyst was also stable up to 4000 and 1000 CV cycles under alkaline and neutral electrolytes, respectively.

The EIS spectra of the Ru_{SA}—N—S—Ti₃C₂Tₓ single atom catalyst before and after CV cycling in alkaline and neutral electrolytes showed only a slight increase in the charge transfer resistance even after several CV cycles (4000 cycles in alkaline electrolyte and 1000 cycles in neutral electrolyte). The long-term chemical stability of the Ru_{SA}—N—S—Ti₃C₂Tₓ single atom catalyst could be attributed to the thiourea-assisted carbonization that occurred during the synthesis of the Ru_{SA}—N—S—Ti₃C₂Tₓ single atom catalyst upon thermal annealing under inert atmosphere. The carbonization process largely prevented the surface of the MXene support material from oxidation and thereby preserved the MXene structure during the HER process. Moreover, the single atom ruthenium (Ru_{SA}) were strongly bonded with the MXene support material via the nitrogen and sulfur binding sites, as was evidenced from the XAFS results. Overall, the electrochemical results suggested that the Ru_{SA}—N—S—Ti₃C₂Tₓ single atom catalyst is an efficient and stable electrocatalyst for HER.

To gain more insight into the enhanced HER performance, the double-layer capacitance (C_{dl}) of the catalysts was calculated from the CV measurements obtained in 0.5 m H₂SO₄ and CV curves of the Ru_{SA}—N—S—Ti₃C₂Tₓ single atom catalyst at different scan rates ranging from 5 to 100 mV s⁻¹ were obtained. Similarly, the CV curves of Ti₃C₂Tₓ at different scan rates were also obtained. The C_{dl} value of the Ru_{SA}—N—S—Ti₃C₂Tₓ single atom catalyst was determined to be 31 mF cm⁻², which was 62 times higher than that of Ti₃C₂Tₓ (0.5 mF cm⁻²). This indicated the high electrochemically active area with exposed catalytic active sites available on the Ru_{SA}—N—S—Ti₃C₂Tₓ single atom catalyst, which were favorable for boosting the HER performance.

Turnover frequency (TOF) is an important factor used to evaluate the HER activity of a catalyst. The TOF value of the Ru_{SA}—N—S—Ti₃C₂Tₓ single atom catalyst in 0.5 m H₂SO₄ electrolyte was calculated based on the ICP-OES analysis. Based on these results, the TOF values of the Ru_{SA}—N—S—Ti₃C₂Tₓ single atom catalyst at 100, 150, and 200 mV were estimated to be 0.52, 0.87, and 1.50 s⁻¹, respectively. The TOF values of the Ru_{SA}—N—S—Ti₃C₂Tₓ single atom catalyst were comparable with reported transition metal-based HER catalysts in acidic electrolyte, which indicated the exceptional activity of the catalyst.

It is believed that this reported HER performance is superior to that of other MXene-based HER catalysts reported thus far. Further, the HER performance of the Ru_{SA}—N—S—Ti₃C₂Tₓ single atom catalyst was also comparable with many recently reported precious transition metals based HER electrocatalysts in acidic solution.

For comparison, different metals (Fe, Co, Ni, and Pt) anchored to the Ti₃C₂Tₓ MXene catalyst were prepared under the same experimental conditions and their HER performance was compared to the Ru_{SA}—N—S—Ti₃C₂Tₓ single atom catalyst. Among them, Ru_{SA}—N—S—Ti₃C₂Tₓ catalyst was found to be a superior HER catalyst, with the lowest overpotential value compared to that of Fe—N—S—Ti₃C₂Tₓ, Co—N—S—Ti₃C₂Tₓ, NiN—S—Ti₃C₂Tₓ, and Pt—N—S—Ti₃C₂Tₓ catalysts in acidic electrolyte.

In order to understand the catalytic active sites in the Ru_{SA}—N—S—Ti₃C₂Tₓ single atom catalyst, a potassium thiocyanate ion (KSCN⁻) test in 0.5 m H₂SO₄ was conducted. It is widely known that KSCN⁻ ions have the ability to block metal sites under acidic conditions. Therefore, the HER polarization curves of the Ru_{SA}—N—S—Ti₃C₂Tₓ single atom catalyst were measured before and after the addition of KSCN⁻ ions to the 0.5 m H₂SO₄ electrolyte. The addition of 40×10⁻³ m KSCN⁻ ions increased the overpotential from 235 to 400 mV in order to reach a current density of 80 mA cm⁻². Further increasing the KSCN⁻ion concentration to 80×10⁻³ m did not further affect the performance, which indicated that all isolated metal sites were blocked by the KSCN⁻ ions. However, the overpotential achieved after KSCN⁻ addition was still lower than the overpotential of Ti₃C₂T, MXene, which suggested that the single atom ruthenium (Ru_{SA}) are not the sole source of active sites for the enhanced HER performance of the Ru_{SA}—N—S—Ti₃C₂Tₓ single atom catalyst.

In order to further understand the effective role of the Ti₃C₂T, support material as a potential support for HER, reduced graphene oxide (rGO) was used as an alternative support material to anchor the single atom ruthenium. The Ru—N—S-rGO catalyst exhibited an overpotential of 231 mV at 10 mA cm⁻², which was 155 mV higher overpotential than was observed for the Ru_{SA}—N—S—Ti₃C₂Tₓ single atom catalyst. This indicates the effective role of the MXene support material as a solid support for catalytic reactions.

Based on the XPS and XAFS results, DFT calculations were performed to better understand the fundamental mechanism and hydrogen binding energies of the Ru_{SA}—N—S—Ti₃C₂Tₓ single atom catalyst for HER. In general, the hydrogen adsorption energy on a catalyst surface is a key descriptor for studying the HER catalytic performance, in which an ideal catalyst should possess an optimal hydrogen adsorption energy value close to that of platinum (i.e., close to zero). A proposed atomic model of the Ru_{SA}—N—S—Ti₃C₂Tₓ single atom catalyst is illustrated in FIG. 2, where 212 represents the Ti atom, 214 represents the C atom, 216 represents the O atom, 218 represents the F atom, 220 represents the Ru atom, 230 represents the N atom, and 240 represents the S atom.

The energies of the catalysts were calculated. The N—S—Ti₃C₂Tₓ, Ru_{SA}—Ti₃C₂Tₓ , and Ru_{SA}—N—Ti₃C₂Tₓ catalysts offered largely negative Gibbs hydrogen adsorption free energy (ΔGH*) values of −0.86, −0.41, and −0.25 eV, respectively. This indicated the strong H adsorption behavior on these catalysts and thus the high energy barriers for the formation and desorption of H₂. Impressively, the Ru_{SA}—N—S—Ti₃C₂Tₓ single atom catalyst achieved an optimal ΔG H* value of 0.08 eV, which is much closer to zero, highlighting the favorable H adsorption-desorption and subsequent Hz production characteristics of the Ru_{SA}—N—S—Ti₃C₂Tₓ single atom catalyst, enabling it to effectively drive the overall HER process. The optimal AG H* achieved by the Ru_{SA}—N—S—Ti₃C₂Tₓ single atom catalyst could be attributed to the chemical interaction between the single atom ruthenium (Ru_{SA}) and the MXene support material, as was evidenced from the XAFS results.

The partial density of states (PDOS) of the single atom ruthenium (Ru_{SA}) in Ru_{SA}—Ti₃C₂Tₓ, Ru_{SA}—N—Ti₃C₂Tₓ, and Ru_{SA}—N—S—Ti₃C₂Tₓ were also evaluated. The PDOS diagrams showed how doping of single atom ruthenium (Ru_{SA}) induced charge transfer between the single atom ruthenium (Ru_{SA}) and the MXene support material and thereby created nonbonding states around the Fermi energy level. The lower intensity of the nonbonding states and change in density of states indicated that the isolated ruthenium atoms optimized the catalytic activity, which matched the trend of ΔGH*. Furthermore, the total density of states (TDOS) analysis confirmed that the Ti₃C₂Tₓ MXene support material can be used as a solid support with good electronic conductivity. The TDOS of Ti₃C₂Tₓ, N—STi₃C₂Tₓ, Ru_{SA}—Ti₃C₂Tₓ, Ru_{SA}—N—Ti₃C₂Tₓ, and Ru_{SA}—N—S—Ti₃C₂Tₓ demonstrated that all the systems possess metallic characteristics, which is beneficial for the electrocatalytic HER. Overall the DFT results strongly suggested that the decoration of single atom ruthenium (Ru_{SA}) onto the MXene support material altered the electronic structure of the single atom ruthenium (Ru_{SA}) with optimal ΔG H* to effectively facilitate the HER process.

Photoelectrochemical (PEC) water splitting is one of the economically viable approaches for producing clean solar hydrogen. Accordingly, Ti₃C₂Tₓ and Ru_{SA}—N—S—Ti₃C₂Tₓ electrocatalysts were integrated with n+ np+-Si photocathode to evaluate their PEC H₂ production performance. The PEC device structure of the Ru_{SA}—N—S—Ti₃C₂Tₓ In+ np+-Si photocathode can be seen in FIG. 3, which was discussed above.

It has been previously shown that the drop-casting of Ti₃C₂Tₓ MXene can easily form a Schottky junction with n-Si by just van der Waals forces. Therefore, the Ru_{SA}—N—S—Ti₃C₂Tₓ catalyst was directly drop-cast onto the n+ side of the Si photocathode. The work function and band alignment of the Ru_{SA}—N—S—Ti₃C₂Tₓ /n+ np+-Si photocathode were investigated using ultraviolet photoelectron spectroscopy (UPS). The secondary electron cutoff energy obtained from the UPS spectra can be subtracted from the incident UV photon energy (He I excitation energy of 21.21 eV) to calculate the work function of the materials. In case of n+ np+-Si, the secondary electron cutoff energy was 17.26 eV and its corresponding work function was calculated to be 21.21-17.26 eV=3.95 eV. However, the secondary electron cutoff energy of the Ru_{SA}—N—S—Ti₃C₂Tₓ single atom catalyst shifted toward low binding energy (16.96 eV) compared to n+ np+-Si, the work function of the Ru_{SA}—N—S—Ti₃C₂Tₓ single atom catalyst was estimated to be 21.21-16.96 eV=4.25 eV, which was higher than the work function of n+ np+-Si. Moreover, the work function of the Ru_{SA}—N—S—Ti₃C₂Tₓ single atom catalyst was comparable with previously reported work function values for Ti₃C₂Tₓ MXene.

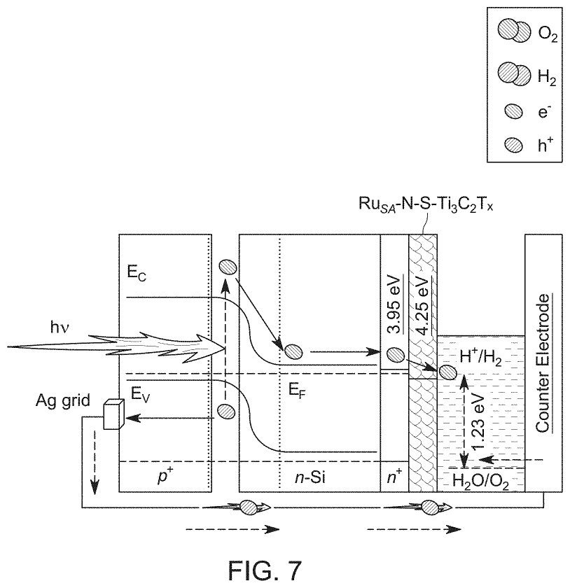

Based on the work functions, a band structure diagram for Ru_{SA}—N—S—Ti₃C₂Tₓ/n+ np+-Si photocathode was prepared, which is illustrated in FIG. 7. As illustrated, upon light illumination, the photogenerated electrons from n+ np+-Si photocathode can promptly migrate to the surface of the Ru_{SA}—N—S—Ti₃C₂Tₓ single atom catalyst due to the difference in the work functions. Thus, the continuous shuttle of these photogenerated electrons to the active sites of the Ru_{SA}—N—S—Ti₃C₂Tₓ single atom catalyst can prevent the charge carrier recombination on Si and Si/Ru_{SA}—N—S—Ti₃C₂Tₓ interface and thereby efficiently enhances the PEC H₂ production performance.

SEM images of the p+- and n+-Si surfaces of the device, as well as the n+-Si side after the deposition of the Ru_{SA}—N—S—Ti₃C₂Tₓ single atom catalyst were obtained. The n+-Si surface of the photocathode featured micropyramidal structures for improved light absorption, while the p+-Si surface was grooved. The

SEM image of the Ru_{SA}—N—S—Ti₃C₂Tₓ/n+ np+-Si photocathode clearly showed that the Ru_{SA}—N—S—Ti₃C₂Tₓ single atom catalyst uniformly coated the grooved surface of the n+ np+-Si.

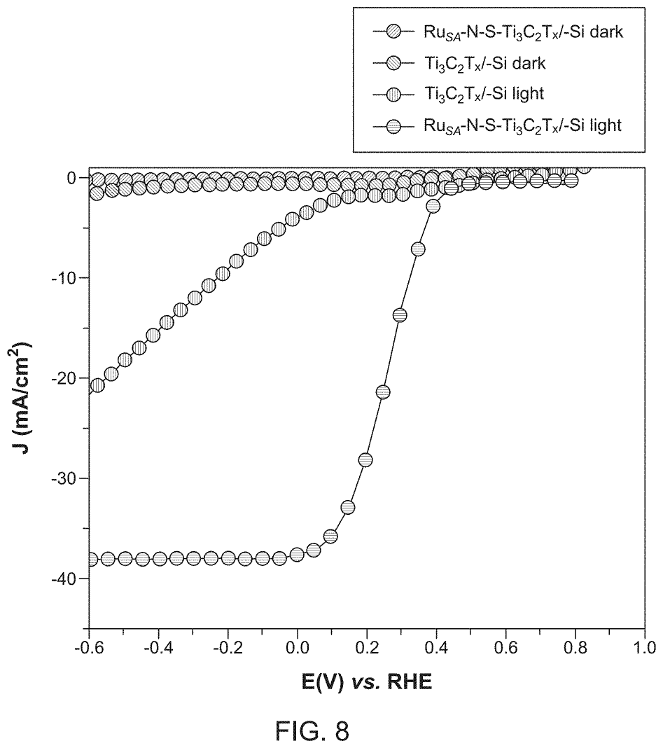

FIG. 8 is a graph of the current density-voltage (J-V) characteristic curves of the Ti₃C₂Tₓ/n+ np+-Si and Ru_{SA}—N—S—Ti₃C₂Tₓ /n+np+-Si photocathodes under dark and illuminated conditions. Upon AM 1.5G illumination, the Ti₃C₂Tₓ/n+ np+-Si photocathode exhibited a photocurrent density of 3.7 mA cm⁻² @1 mA cm⁻² and an onset potential of 82 mV versus RHE. Remarkably, the Ru^{SA}—N—S—Ti₃C₂Tₓ/n+ np+-Si photocathode exhibited an onset potential of 455 mV versus RHE@1 mA cm⁻² and a photocurrent density of 37.6 mA cm⁻², which is ≈10 times higher than the photocurrent density of the Ti₃C₂Tₓ/n+ np+-Si photocathode.

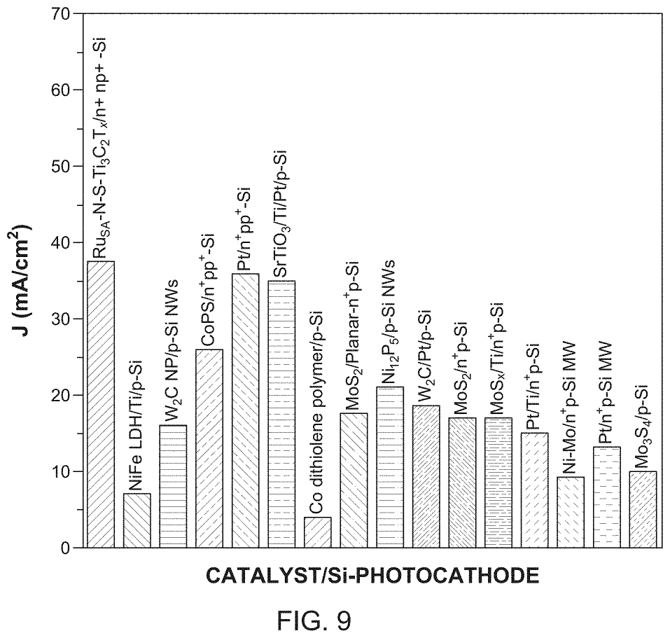

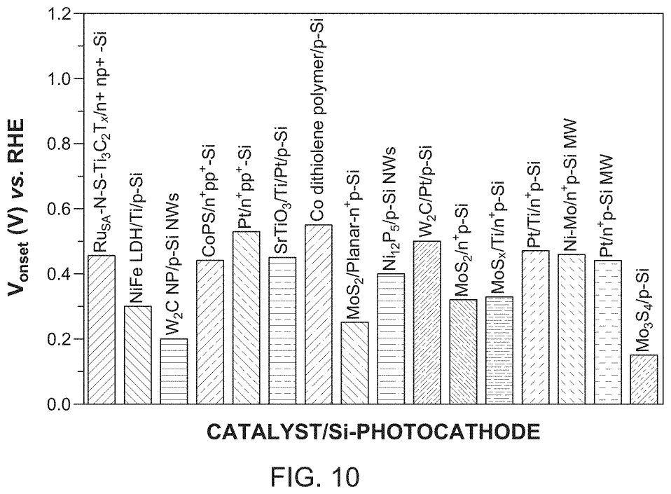

The long-term stability of Ru_{SA}—N—S—Ti₃C₂Tₓ/n+ np+-Si photocathode was evaluated in 0.5 m H₂SO₄ electrolyte under AM 1.5G illumination. The photocurrent density gradually decreased with respect to the reaction time, which might have been due to the gradual removal of Ru_{SA}—N—S—Ti₃C₂Tₓ catalyst from n+ np+-Si surface during PEC H₂ production reaction. The outstanding PEC performance of the Ru_{SA}—N—S—Ti₃C₂Tₓ/n+ np+-Si photocathode was due to the excellent HER activity of the Ru_{SA}—N—S—Ti₃C₂Tₓ single atom catalyst. As illustrated in FIG. 9, the photocurrent density value of Ru_{SA}—N—S—Ti₃C₂Tₓ/n+ np+-Si photocathode was even better than most transition metals and earth-abundant HER catalysts integrated on Si-based photocathodes reported thus far. Additionally, as illustrated in FIG. 10, the onset potential of the Ru_{SA}—N—S—Ti₃C₂Tₓ In+ np+-Si photocathode was comparable with most reported transition metals and earth-abundant HER electrocatalysts coupled to Si photocathodes. The PEC results discussed herein demonstrate that the integration of a hydrophilic and electrically conductive MXene-based electrocatalyst with a Si photocathode could provide a scalable approach toward developing high-performance Si photocathodes for solar-driven PEC water splitting applications.

Thus, the evaluations discussed above demonstrated that the Ru_{SA}—N—S—Ti₃C₂Tₓ single atom catalyst is an efficient and stable HER electrocatalyst. The HER performance of the Ru_{SA}—N—S—Ti₃C₂Tₓ single atom catalyst was superior to other previously reported MXene-based HER catalysts and most transition metal-based HER catalysts. XAFS and DFT simulation studies revealed that the remarkable HER catalytic activity of the Ru_{SA}—N—S—Ti₃C₂Tₓ single atom catalyst is mainly due to the catalytically active interfaces of the Ru_{SA}—Ti₃C₂Tₓ MXene support material and its optimal ΔG H* value. Furthermore, incorporating the Ru_{SA}—N—S—Ti₃C₂Tₓ single atom catalyst into a n+ np+-Si photocathode significantly boosts the photocurrent density to 37.6 mA cm-2, which is 10 times higher than that of the Ti₃C₂Tₓ/n+ np+-Si photocathode. Both experimental and theoretical studies clearly demonstrate that the catalytic properties of MXenes can be tailored via metal-support interactions.

Although the description above has presented an evaluation of a specific single atom catalyst, i.e., Ru_{SA}—N—S—Ti₃C₂Tₓ, it is believed that similar improved performance can be achieved using other types of two-dimensional support materials, other types of single atom metal, and other heteroatoms than discussed in connection with the specific example. Again, the improved performance revealed by the evaluation of the specific single atom catalyst demonstrated the significance of using heteroatoms to improving the device performance. Indeed, as discussed above in connection with the specific example, the use of the heteroatoms to bind and stabilize the single atom metal resulted in a device that performed better than a catalyst having single atom platinum directly bound (i.e., without heteroatoms) to an MXene sheet, such as the catalyst disclosed in Reference Document [1].

The disclosed embodiments provide a single atom catalyst on a two-dimensional support material and methods of production. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

Zhang, J., Zhao, Y., Guo, X. et al. Single platinum atoms immobilized on an MXene as an efficient catalyst for the hydrogen evolution reaction. Nat Catal 1,985-992 (2018).

1. A method for forming a single atom catalyst on a two-dimensional support material, the method comprising:
providing the two-dimensional support material;
combining the two-dimensional support material with at least two heteroatoms and a metal to form a solution;
removing liquid from the solution to form a material comprising the two-dimensional support material, the at least two heteroatoms, and the metal; and
heating the material comprising the two-dimensional support material, the at least two heteroatoms, and the metal to form the single atom catalyst comprising single atoms of the metal, wherein the at least two heteroatoms bind the single atoms of the metal to, and stabilize the single atoms of metal on, the two-dimensional support material.

2. The method of claim 1, wherein the liquid is removed from the solution by freeze-drying, which forms a foam comprising the two-dimensional support material, the at least two heteroatoms, and the metal.

3. The method of claim 1, wherein the heating comprises annealing.

4. The method of claim 1, wherein the two-dimensional support material is an MXene and the provision of the two-dimensional support material comprises forming the MXene from a MAX phase material, wherein M is a transition metal, A is a main group element, and X is carbon or nitrogen.

5. The method of claim 4, wherein the MAX phase material is titanium aluminum carbide, Ti₃AlC₂, and the MXene is titanium carbide Tₓ, Ti₃C₂Tₓ wherein Tₓ is a functional group element.

6. The method of claim 5, wherein the metal is ruthenium.

7. The method of claim 6, wherein a first one of the at least two heteroatoms is sulfur and a second one of the at least two heteroatoms is nitrogen.

8. The method of claim 5, wherein the metal is platinum.

9. A single atom catalyst, comprising:
a two-dimensional support material;
at least one single atom metal; and
first and second heteroatoms binding the at least one single atom metal to, and stabilizing the at least one single atom metal on, the two-dimensional support material.

10. The single atom catalyst of claim 9, wherein the two-dimensional support material is graphene.

11. The single atom catalyst of claim 9, wherein the two-dimensional support material is an MXene.

12. The single atom catalyst of claim 11, wherein the MXene is titanium carbide Tₓ, Ti₃C₂Tₓ.

13. The single atom catalyst of claim 9, wherein the at least one single atom metal is ruthenium or platinum.

14. The single atom catalyst of claim 13, wherein the first heteroatom is sulfur and the second heteroatom is nitrogen.

15. The single atom catalyst of claim 9, wherein the first heteroatom bound to the first single atom metal is one of a plurality of first heteroatoms bound to one of a plurality of first single atom metals and the second heteroatom bound to the second single atom metal is one of a plurality of second heteroatoms bound to one of a plurality of second single atom metals, and wherein the plurality of first heteroatoms bound to one of the plurality of first single atom metals and the plurality of second heteroatoms bound to one of the plurality of second single atom metals are distributed across the two-dimensional support material.

16. A water splitting device, comprising:
a metal anode; and
a semiconductor photocathode, spaced apart from the metal anode and having a first side facing the metal anode, wherein the first side of the photocathode comprises a single atom catalyst comprising
a two-dimensional support material;
at least one single atom metal; and
first and second heteroatoms binding the at least one single atom metal to, and stabilizes the at least one single atom metal on, the two-dimensional support material.

17. The water splitting device of claim 16, wherein the semiconductor photocathode is a n+np+-Si photocathode and the first side of the semiconductor photocathode comprises an n+ silicon layer on which the single atom catalyst is arranged.

18. The water spitting device of claim 16, wherein the semiconductor photocathode includes a metallic contact that is electrically connected to the metal anode.

19. The water splitting device of claim 16, wherein the two-dimensional support material is a titanium carbide Tₓ, Ti₃C₂Tₓ MXene.

20. The water splitting device of claim 19, wherein the at least one single atom metal is ruthenium, the first heteroatom is sulfur, and the second heteroatom is nitrogen.
